(19) United States
(12) Patent Application Publication
(10) Pub. No.: US 2009/0292756 A1
(43) Pub. Date: Nov. 26, 2009

(54) Large-factor multiplication in an array of processors

(76) Inventors: Gibson D. Elliot, Oak Run, CA (US); Jay Randall Stoner, Redding, CA (US)

Correspondence Address: HENNEMAN & ASSOCIATES, PLC, 70 N. MAIN ST., THREE RIVERS, MI, 49093, US

(21) Appl. No.: 12/154,679

(22) Filed: May 23, 2008

(51) Int. Cl. G06F 7/38

(52) U.S. Cl. 708/523

(57) ABSTRACT

A processor to calculate a product-component having fewer digits than an entire product of a multiplication of a multiplicand and a multiplier. A memory holds at least one multiplicand-component having fewer digits than the multiplicand and at least one multiplier-component having fewer digits than the multiplier. A logic then calculates the product-component based on the multiplicand-components and the multiplier-components in the memory. Collectively, a plurality of the processors can calculate all of the product-components of the product.

### BACKGROUND OF THE INVENTION

1. Technical Field

The present invention relates generally to electrical computers and digital processing systems having processing architectures and performing instruction processing, and more particularly to processes for multiplication that can be implemented in such.

2. Background Art

Multiplication is an operation used extensively in many important applications today, like digital signal processing (DSP), obtaining large prime numbers for use in the RSA cryptography algorithm, and many others. When two factors are being multiplied the factors are usually termed the multiplicand and the multiplier and the result is termed the product.

Most people are familiar with a ‘pencil and paper’ approach to multiplying two factors by performing a series of smaller multiplications to produce partial products that are then added together to yield a final product. Even though this is often tedious and may not be the most efficient approach, it can be used for factors of any size and it will produce the correct product.

The importance of multiplication has led to the development of many methods for performing it using computers. Unfortunately, computer multiplication can have drawbacks. For example, many computers have hardware based multiply functions, but these can only produce correct results when the factors are limited to certain maximum bit lengths. Other computers have operational code (op-code software) based multiply functions, but these also are only able to produce correct results when the factors are limited to certain maximum bit lengths.

Of course, many computers can mimic the pencil and paper approach, but this has to be done programmatically using high level software that employs either a hardware based or an op-code based multiply function. Various problems exist such high level software approaches. A particularly burdensome one is that these typically employ object-oriented methodologies or otherwise ‘wrap’ each task such that function calls and returns, state saves and restores, stack pushes and pops, etc. are performed every time the task is performed. This added ‘overhead’ to perform the underlying task takes considerable time and consumes appreciable processor resources, and for tasks that are essentially fundamental or are performed in quantity, like multiplication, this can be a severe burden.

Accordingly, regardless of whether a computer performs multiplication using a hardware based or an op-code based approach, there are restrictions on performing the multiplication of factors having large digit counts (i.e., performing “large-factor” multiplication).

### BRIEF SUMMARY OF THE INVENTION

Accordingly, it is an object of the present invention to provide for large-factor multiplication in an array of processors.

Briefly, one preferred embodiment of the present invention is a processor to calculate a product-component having fewer digits than an entire product of a multiplication of a multiplicand and a multiplier. A memory holds at least one multiplicand-component having fewer digits than the multiplicand and at least one multiplier-component having fewer digits than the multiplier. A logic then calculates the product-component based on the multiplicand-components and the multiplier-components in the memory.

Briefly, another preferred embodiment of the present invention is a process to calculate a product-component having fewer digits than an entire product of a multiplication of a multiplicand and a multiplier. At least one multiplicand-component is provided that has fewer digits than the multiplicand. Similarly, at least one multiplier-component is provided that has fewer digits than the multiplier. The product-component is then calculated based on the multiplicand-components and the multiplier-components.

Briefly, another preferred embodiment of the present invention is a system to multiply a multiplicand and a multiplier to calculate a product, wherein the multiplicand is represented by multiple multiplicand-components each having fewer digits than the multiplicand, the multiplier is represented by multiple multiplier-components each having fewer digits than the multiplier, and the product is represented by multiple product-components each having fewer digits than the product. A plurality of processors are provided and are ordered lowest, middle, and highest based on an ordering of the product-components in the product. These processors include a lowest processor having a carry-value logic to calculate and provide a carry-value to another processor, and a product-component logic to calculate a product-component. These processors also include one or more middle processors each also having a carry-value logic and a product-component logic. And these processors include a highest processor also having a product-component logic. In the carry-value logic in the lowest processor the carry-value is calculated based on a multiplicand-component and a multiplier-component. In the carry-value logic in the middle processors, each carry-value is calculated based on at least one multiplicand-component, at least one multiplier-component, and a carry-value that was calculated by another processor. In the product-component logic in the lowest the processor the product-component is calculated based on a multiplicand-component and a multiplier-component. In the product-component logic in the middle processors each product-component is calculated based on at least one multiplicand-component, at least one multiplier-component, and a carry-value that was calculated by another processor. And in the product-component logic in the highest processor the product-component is calculated based on a carry-value that was calculated by another processor.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIGS. 1a-b (prior art) illustrate a traditional method for multiplying two 3-digit factors, wherein FIG. 1a is a block diagram showing how this method includes nine similar stages that each produces a partial product and FIG. 1b includes a table that shows how the partial products from each of the nine stages in FIG. 1a can be organized and added to obtain a final product of the multiplication.

FIGS. 2a-b illustrate an alternate method for multiplying two 3-digit factors, wherein FIG. 2a is a block diagram showing how this alternate method includes five similar stages that produce the same partial products as those produced by the traditional method and FIG. 2b includes a table that shows how the partial products from each of the five stages in FIG. 2a can be organized and added to obtain a final product of the multiplication.

FIGS. 3a-c (background art) show information about a hardware platform usable by the present invention, wherein FIG. 3a is a block diagram showing how this device has multiple cores or nodes (i.e., individual processors) on a single semiconductor die, FIG. 3b is a schematic block diagram showing the general architecture of the device, and FIG. 3c is a table listing the op-codes ofthe device.

FIG. 4 is a block diagram illustrating how the inventive large-factor multiplication system can be used in the device of FIGS. 3a-c to multiply two large-factors.

And FIG. 5 is a flow chart showing a generalized node-level process that is in accord with the large-factor multiplication system.

In the various figures of the drawings, like references are used to denote like or similar elements or steps.

### DETAILED DESCRIPTION OF THE INVENTION

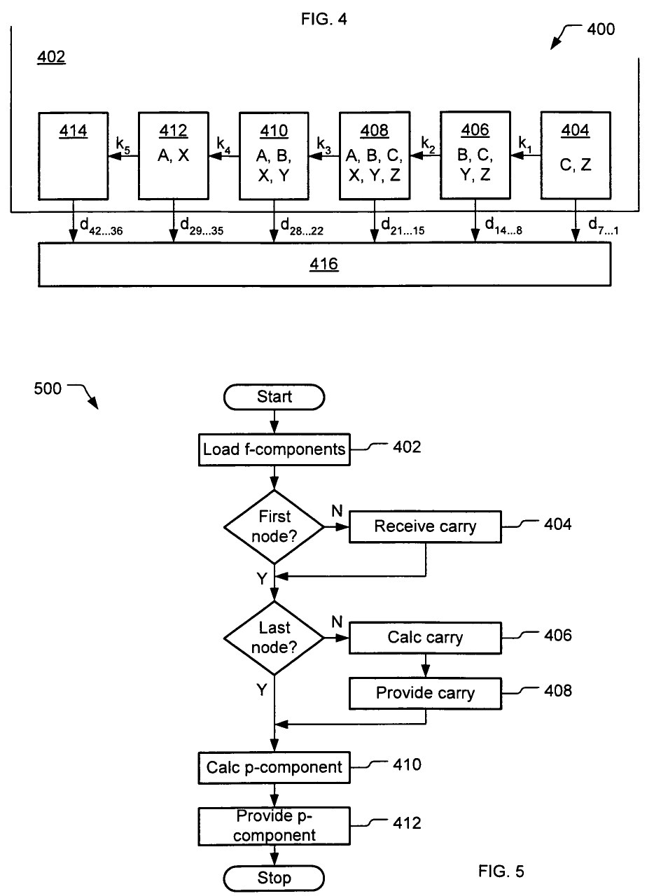

A preferred embodiment of the present invention is a system for large-factor multiplication in an array of processors. As illustrated in the various drawings herein, and particularly in the view of FIG. 4, preferred embodiments of the invention are depicted by the general reference character 400.

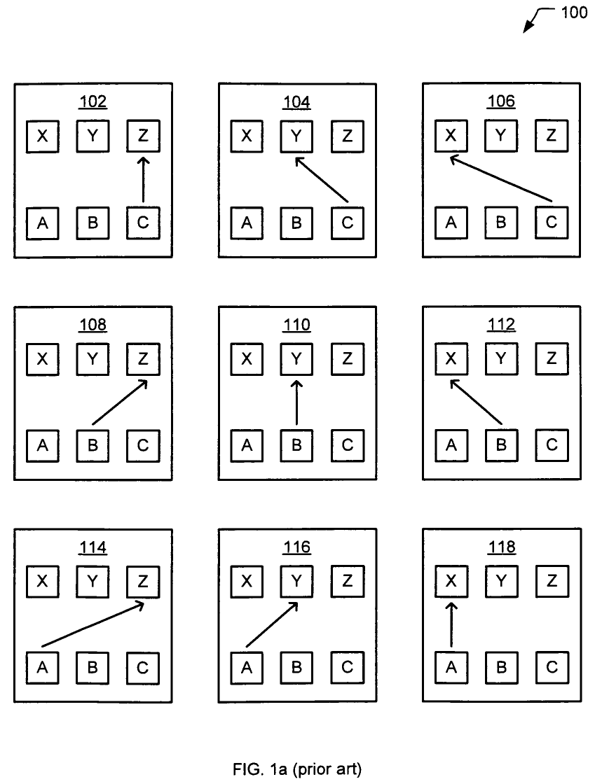

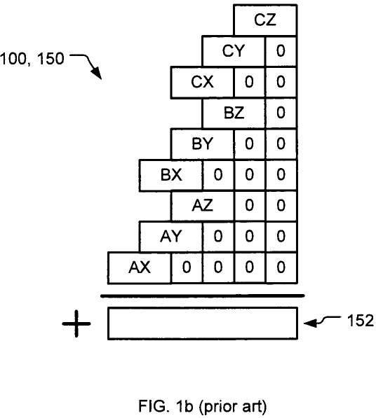

FIGS. 1a-b (prior art) illustrate with an example one well known traditional method 100 for multiplying two 3-digit factors. This traditional method 100 is frequently used for pencil and paper multiplication by hand. FIG. 1a is a block diagram showing how the traditional method 100 includes nine similar stages 102-118 that each produces a partial product. And FIG. 1b includes a table 150 that shows how the partial products from each of the nine stages 102-118 in FIG. 1a can be organized and added (in effectively a tenth stage) to obtain a final product 152 of the multiplication when the traditional method 100 is used.

In FIG. 1a each of the stages 102-118 contains the same six sub-blocks, labeled A, B, C, X, Y, and Z. The first grouping of A, B, and C represent the multiplicand factor, ABC, and the second grouping of X, Y, and Z represent the multiplier factor, XYZ. Each of the letters A, B, C, X, Y, and Z here correspond with a single digit. For the multiplicand ABC, A is the most significant digit (MSD), C is the least significant digit (LSD), and B is the middle digit. Similarly, for the multiplier XYZ, X is the MSD, Z is the LSD, and Y is the middle digit.

In stage 102 the LSD of factor ABC and the LSD of factor XYZ are multiplied, producing the partial product CZ.

In stage 104 the LSD of factor ABC and the middle digit of factor XYZ are multiplied, producing the partial product CY. However, since the middle digit (Y) of factor XYZ is of the second order of magnitude in the numbering system being used, the partial product CY is adjusted by shifting it one order of magnitude higher and zero-filling the vacated low order digit position, achieving the result shown in FIG. 1b. Effectively, this is the same as multiplying the partial product by the base of the numbering system being used.

When humans use the traditional method 100 with base-ten numbers they typically do not think of orders of magnitude and of this adjustment as shifting and zero filing. Instead, they think of it either as a very simply route operation where they ‘put in a zero’ or, if they recall the principles they were taught in school, they think of it as an additional simple multiplication. For example, if factor ABC is 123₁₀ and factor XYZ is 456₁₀, CY is 15₁₀ but the partial product that is used for the rest of the traditional method 100 is 150₁₀ (which is 15₁₀*10₁₀). Generalizing, however, these approaches work for any number base and this particularly includes base-two numbers which are used widely in digital computing devices.

Continuing with FIG. 1a, in stage 106 the LSD of factor ABC and the MSD of factor XYZ are multiplied, producing the partial product CX. However, since one of the digits here (X) is two orders of magnitude ‘above’ the LSD of its factor, the partial product CX is adjusted by shifting two orders of magnitude higher and zero-filling the two vacated low order digit positions. Of course, this can also be viewed as putting in two zeros or as multiplying by the base of the numbering system two times. For example, again using factor ABC=123₁₀ and factor XYZ=456₁₀, CZ is 12₁₀ but the partial product that will be used later is 1200₁₀ (which is 12₁₀*10₁₀*10₁₀).

In stage 108 the middle digit of factor ABC and the LSD of factor XYZ are multiplied. However, since one of the digits here (B) is one order of magnitude ‘above’ the LSD of that factor, the partial product BZ is adjusted by shifting one order of magnitude higher and zero-filling the one vacated low order digit position. The result can be seen in table 150.

In stage 110 the middle digit of factor ABC and the middle digit of factor XYZ are multiplied. However, since both of the digits here (B and Y) are each one order of magnitude ‘above’ the LSD of the respective factors they are part of, the partial product BY is adjusted by shifting two orders of magnitude higher and zero-filling the two vacated low order digit positions. The result of this can also be seen in table 150.

Similar operations in accord with the preceding are performed in stages 112-118, with the results viewable in table 150.

The table 150 in FIG. 1b contains all of the partial products that are needed. Additionally, FIG. 1b effectively shows a tenth stage, where the partial products are added to obtain the final product 152 of the multiplication being performed by using the traditional method 100.

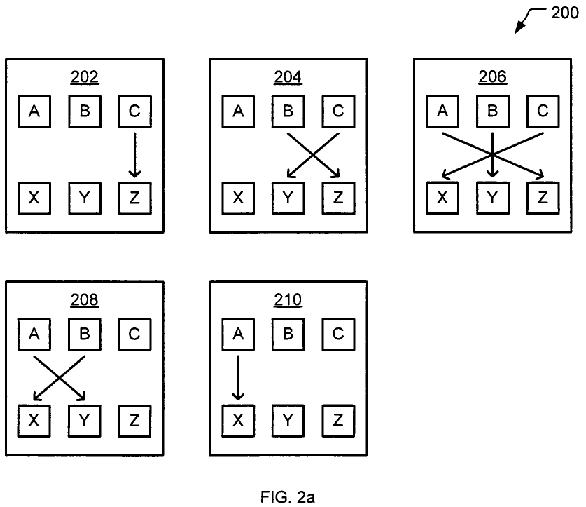

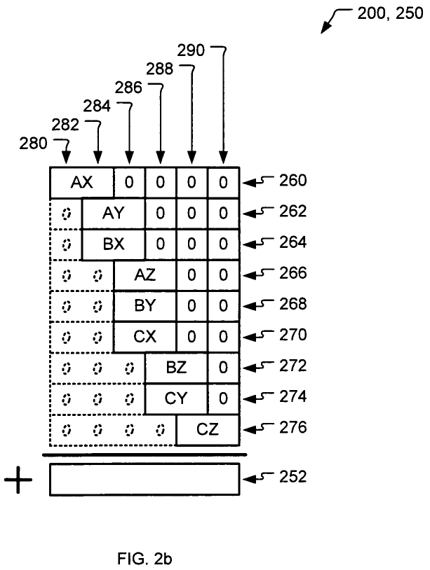

FIGS. 2a-b illustrate with an example an alternate method 200 for multiplying two 3-digit factors. Again, factor ABC is used as the multiplicand and factor XYZ is used as the multiplier. FIG. 2a is a block diagram showing how the alternate method 200 includes five similar stages 202-210 that produce the same partial products as those produced by the traditional method 100. And FIG. 2b includes a table 250 that shows how the partial products from each of the five stages 202-210 in FIG. 2a can be organized and added (essentially in a sixth stage here) to obtain a final product 252 of the multiplication when the alternate method 200 is used.

To facilitate discussion of some points here, the table 250 is organized into rows 260-276 and columns 280-290, where each row corresponds to one partial product and each column corresponds to a single digit needed to represent the final product 252 of ABC with XYZ.

For example, entry (260, 290) holds the zero located in the upper right corner of table 250. Six columns are shown in table 250 because the product of two three-digit factors will have at most six digits when the alternate method 200 is used. The multiplication of two factors consisting of n significant digits and m significant digits, respectively, results in a product which has no more than n+m digits. However, the resultant product can be shown in n+m digits where zeroes fill the leading non-significant digits (shown in ghost outline in FIG. 2b). Nine rows are shown in table 150 because the product of two three-digit factors will produce nine partial products when the alternate method 200 is used (for the same reason that the traditional method 100 will produce nine partial products when multiplying two three-digit factors).

In FIG. 2a stage 202 C and Z are multiplied, producing the partial product CZ. Accordingly, in FIG. 2b the partial product CZ is placed into table 250 in entry (276, 288-290).

In stage 204 two partial products (CY and BZ) are produced that will be used to produce the final product 252 of factor ABC and factor XYZ. The partial product CY is put into table 250 at entry (274, 286-288) and the partial product BZ is put into table 250 at entry (272, 286-288). Both of these partial products are shifted one order of magnitude higher and zero-filled, for the same reasons discussed above with respect to the traditional method 100.

In stage 206 three partial products (CX, BY, and AZ) are produced that will be used to produce the final product 252 of factor ABC and factor XYZ. These partial products are put into table 250 in entry (270, 284-286), entry (268, 284-286), and entry (266, 284-286), respectively. All three of these partial products are also shifted two orders of magnitude higher and zero-filled, for the same reasons discussed above with respect to the traditional method 100.

In stage 208 two partial products (BX and AY) are produced, which are put into table 250 in entry (264, 282-284) and entry (262, 282-284), each shifted three orders of magnitude higher and zero-filled.

In stage 210 one partial product (AX) is produced, which is put into table 250 in entry (260, 280-282), shifted four orders of magnitude higher, and zero-filled.

With reference briefly back to FIG. 1b also, it can be seen that there are similarities between table 150 and table 250. In table 150 each of the rows represents a partial product, in table 250 each of the rows 260-276 also represents a partial product. Furthermore, these two sets of partial products are the same except for the order in which they appear. The final product 152 and the final product 252 will also be the same, since the partial products are the same and addition is commutative. In FIG. 2b the partial products are shown with leading zeros, but this is effectively the same for the partial products shown in FIG. 1b. People generally do not ‘write out’ such leading zeros when using pencil and paper, but the traditional method 100 works the same when this is done, and when either the traditional method 100 or the alternate method 200 are performed in a computing device this is usually explicitly done.

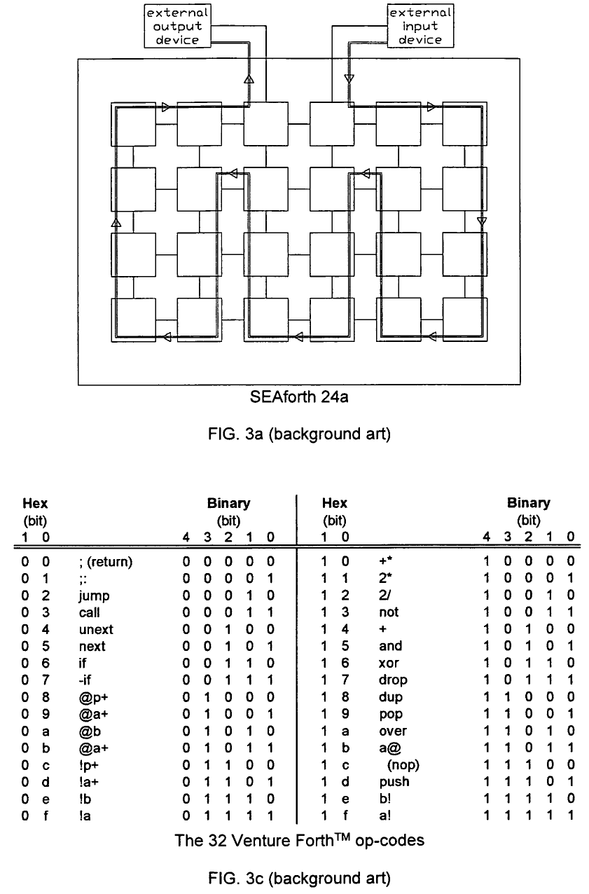

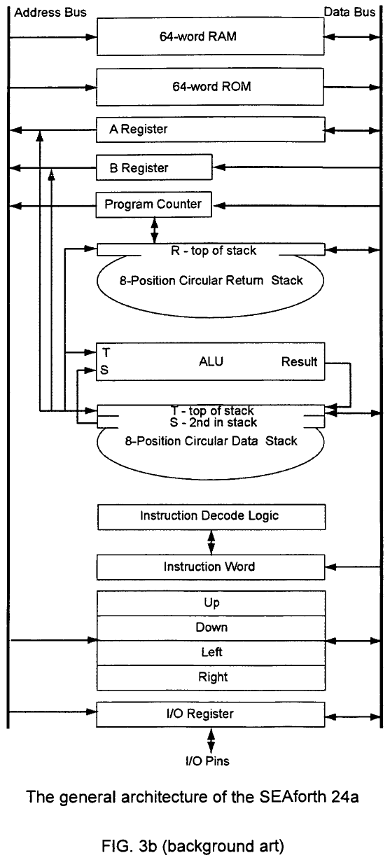

The present inventive large-factor multiplication system 400 (FIG. 4) is usable in many hardware platforms. For the sake of an example, the 24-processor SEAforth®-24A device by IntellaSys® Corporation of Cupertino, Calif. is used herein. This device has 24 essentially identical processors on a single semiconductor die that do not contain a hardware multiply function. Multiplication in the cores or nodes of a SEAforth®-24A device is usually performed by using op-code combinations. FIGS. 3a-c (background art) show additional information about the SEAforth®-24A device. FIG. 3a is a block diagram showing how this device has 24 cores or nodes (i.e., individual processors) on a single semiconductor die. FIG. 3b is a schematic block diagram showing the general architecture of the SEAforth®-24A device. And FIG. 3c is a table listing the 32 Venture Forth™ op-codes of the SEAforth®-24A device.

As noted, the cores in the SEAforth®-24A device do not have a hardware based multiply function. Instead they have an op-code based multiply which will produce the correct product under certain conditions. For example, if only the T and S registers are used to contain the multiplier and the multiplicand, then the largest product which can be produced by the op-code based multiply is 2¹⁸−1, or 262,143, which is not a particularly large value.

Employing the inventive large-factor multiplication system 400 (FIG. 4) in the 24 core array of processors in the SEAforth®-24A device very beneficially permits multiplying either two factors having very large values (i.e., large digit counts) or performing a series of multiplications on very large values without having a great deal of latency in the process.

FIG. 4 is a block diagram illustrating how the inventive large-factor multiplication system 400 can be used to multiply two 21-bit factors to produce a 42-bit product. The first 21-bit factor, ABC, is represented by a₇a₆a₅a₄a₃a₂a₁b₇b₆b₅b₄b₃b₂b₁c₇c₆c₅c₄c₃c₂c₁, where component A represents the bits a₇a₆a₅a₄a₃a₂a₁, component B represents the bits b₇b₆b₅b₄b₃b₂b₁, and component C represents the bits c₇c₆c₅c₄c₃c₂c₁. The second 21-bit factor, XYZ, is represented x₇x₆x₅x₄x₃x₂x₁y₇y₆y₅y₄y₃y₂y₁z₇z₆z₅z₄z₃z₂z₁, where component X represents the bits x₇x₆x₅x₄x₃x₂x₁, component Y represents the bits y₇y₆y₅y₄y₃y₂y₁, and component Z represents the bits z₇z₆z₅z₄z₃z₂z₁. It should particularly be noticed that the components A, B, C, X, Y, and Z are now representative of seven bits, not the lone digit as previously shown. The way in which the two 21-bit values have been arranged is that the MSB of ABC is a₇ and the LSB of ABC is c₁ and the MSB of XYZ is x₇ and the LSB of XYZ is z₁. The arrangement of the bits for each factor thus is from highest to lowest when the bits are read from left to right. The 42-bit product, D, is represented by d₄₂ . . . d₁.

FIG. 4 shows a processor array 402 in which six nodes 404-414 located at the bottom edge of the die or module are used for large-factor multiplication. It should be observed that utilizing six nodes 404-414 does not require that the factors ABC and XYZ be stored in memory in all six nodes 404-414. In fact, only component parts of the factors ABC and XYZ need to be stored in the respective memories. Similarly, none of six nodes 404-414 handles or has to store all of the 42-bit product D.

The node 404 contains the components C and Z, as a mapping of stage 202 in FIG. 2a to a single core in the processor array 402. The node 404 is responsible for producing the seven least significant bits d₇d₆d₅d₄d₃d₂d₁ of a final product for an element 416 that is external to the processor array 402. The seven least significant bits of the product are calculated by:

$${d}_{i … p} = ⌊ \frac{C * Z}{{b}^{i - 1}} ⌋ mod b \qquad ( 1 )$$

where b is the base used by the processor and p is the number of bits used to represent components A, B, C, X, Y, or Z (in this case p=7). [Note b here with no subscript should not be confused with any of the bits b₇b₆b₅b₄b₃b₂b₁.] In addition to calculating the first seven bits of the product of ABC and XYZ, node 404 is also responsible for producing a carry value k₁ that is passed to node 406. This carry value is calculated by:

$${k}_{1} = ⌊ \frac{C * Z}{{b}^{p}} ⌋ . \qquad ( 2 )$$

The node 406 contains the components B, C, Y, and Z, as a mapping of stage 204 in FIG. 2a to a single core in the processor array 402. The node 406 is responsible for calculating bits d₁₄d₁₃d₁₂d₁₁d₁₀d₉d₈ of the final product for the element 416 by:

$${d}_{i = p + 1 … 2 p} = ⌊ \frac{{k}_{1} + B * Z + C * Y}{{b}^{i - 1 - p}} ⌋ mod b . \qquad ( 3 )$$

The node 406 also produces a carry value k₂ that is passed on to node 408, and which is calculated by:

$${k}_{2} = ⌊ \frac{{k}_{1} + B * Z + C * Y}{{b}^{p}} ⌋ . \qquad ( 4 )$$

The node 408 contains all of the components of factors ABC and XYZ yet still is responsible for only the same number of product bits as the other nodes. The contents of node 408 are a mapping of stage 206 in FIG. 2a to a single core in the processor array 402. The node 408 is responsible for calculating bits d₂₁d₂₀d₁₉d₁₈d₁₇d₁₆d₁₅ of the final product for the element 416 by:

$${d}_{i = 2 p + 1 … 3 p} = ⌊ \frac{{k}_{2} + A * Z + B * Y + C * X}{{b}^{i - 1 - 2 p}} ⌋ mod b . \qquad ( 5 )$$

The node 408 also produces a carry value k₃ that is passed on to node 410, and which is calculated by:

$${k}_{3} = ⌊ \frac{{k}_{2} + A * Z + B * Y + C * X}{{b}^{p}} ⌋ . \qquad ( 6 )$$

The node 410 contains the components A, B, X, and Y, as a mapping of stage 208 in FIG. 2a to a single core in the processor array 402. The node 410 is responsible for calculating bits d₂₈d₂₇d₂₆d₂₅d₂₄d₂₃d₂₂ of the final product for the element 416 by:

$${d}_{i = 3 p + 1 … 4 p} = ⌊ \frac{{k}_{3} + A * Y + B * X}{{b}^{i - 1 - 3 p}} ⌋ mod b . \qquad ( 7 )$$

The node 410 also produces a carry value k₄ that is passed on to node 412, and which is calculated by:

$${k}_{4} = ⌊ \frac{{k}_{3} + A * Y + B * X}{{b}^{p}} ⌋ . \qquad ( 8 )$$

The node 412 contains the components A and X, as a mapping of stage 210 in FIG. 2a to a single core in the processor array 402. The node 412 is responsible for calculating bits d₃₅d₃₄d₃₃d₃₂d₃₁d₃₀d₂₉ of the final product for the element 416 by:

$${d}_{i = 4 p + 1 … 5 p} = ⌊ \frac{{k}_{4} + A * X}{{b}^{i - 1 - 4 p}} ⌋ mod b . \qquad ( 9 )$$

The node 412 also produces a carry value k₅ that is passed on to node 414, and which is calculated by:

$${k}_{5} = ⌊ \frac{{k}_{4} + A * X}{{b}^{p}} ⌋ . \qquad ( 10 )$$

Unlike nodes 404-412, node 414 is not responsible for a carry value, instead it is simply responsible for the seven high order bits d₄₂d₄₁d₄₀d₃₉d₃₈d₃₇d₃₆ of the final and XYZ by:

$${d}_{i = 5 p + 1 … 6 p} = ⌊ \frac{{k}_{5}}{{b}^{i - 1 - 5 p}} ⌋ mod b . \qquad ( 11 )$$

The product of the two 21-bit factors ABC and XYZ is now complete and the 42-bit product D has now been calculated. The choice of the six nodes 404-414 is a convenient mapping of the alternate method 200 from FIG. 2a to the processor array 402 in FIG. 4.

Summarizing, the just described example shows that the inventive large-factor multiplication system 400 can perform multiplication where bit lengths of the factors together are greater than that permitted by the normal constraints of the particular hardware platform being used, e.g., by the 18-bit constraint on op-code based multiplication in the SEAforth®-24A device used in the example above. One of the few requirements for use of the inventive large-factor multiplication system 400 to multiply large-factors in any hardware is that smaller multiplications be able to be performed, but these can be tailored to the constraints of the particular hardware being used. If a particular sub-multiplication cannot be performed, say, because the sum of two sub-factor's bit-lengths is greater than eighteen bits, where that is the maximum hardware or op-code limit of the hardware platform, the large-factor multiplication system 400 can then be used for the sub-multiplication in a recursive manner. And from this it follows that factors of essentially any size may be multiplied by using the inventive large-factor multiplication system 400 as a recursive process.

The large-factor multiplication system 400 lends itself particularly well to being performed on an array of processors where each node is assigned to produce a certain number of output bits. With reference again to FIG. 4, it can be observed how the formula for producing output bits d₈ . . . d₁₄ requires the carry value k₁ from node 404. Hence, it is important in terms of computing speed for the value k₁ to be computed and passed onto node 406 prior to the completion of any output digit values from node 404. Otherwise, node 406 will be asleep during the entire iteration of computing product bits d₁ . . . d₇. In a similar way, the formula for producing output bits d₁₅ . . . d₂₁ relies upon the carry value k₂ from node 406 which in turn relies upon the carry value k₁ from node 404. It is of great importance in terms of execution that, if a node is required to produce a carry value in addition to specific output bits, that the carry value be computed first and passed onto the node in which it is needed, followed then by the action of computing the output bits.

It should also be noted that the result produced by the large-factor multiplication system 400 in the processor array 402 in FIG. 4 is simply a set of bits and it is the arrangement of those bits that yield any significance. For example, in FIG. 4 each of the nodes 404-414 could produce a 7-bit value right justified in an 18-bit field with zeroes filling the leading bits. These six 18-bit values would have no importance until they are combined in a meaningful way in the element 416. With reference back to FIG. 2b and table 250, it can be seen that the reason the partial products there were left justified by 0 to 4 digits has to do with the order of the stage number and the quantity of digits (or bits) that each of the components represent.

In FIG. 4 only the six nodes 404-414 located at the edge of the processor array 402 were used and the external element 416 was generically used for result collection. However, none of these are limitations of the large-factor multiplication system 400. Greater (or lesser) numbers of nodes can be employed. The nodes that are used do not have to be edge-nodes. And the collection element can be any suitable collection mechanism. For instance, multiplication-nodes might be interior nodes and the collection mechanism might be one or more edge-nodes. For that matter, the term “edge” should not be interpreted too literally. The collections mechanism needs to interface between the multiplication-nodes and where the resulting multiplication product is provided, but this may simply be one or more other nodes rather than at a port exiting the hardware platform.

Up to here the large-factor multiplication system 400 has been discussed in its entirety, with respect to all of the six nodes 404-414 and the element 416 in FIG. 4. It is also useful, however, to consider the roles of the nodes. 404-414 individually. Each node calculates a product component, and the equations for this are very similar in form. This can be seen by comparing equations (1), (3), (5), (7), (9), and (11). [Digressing briefly, each of these equations is actually performed p times, but the numerator in the division operation does not change. It need be only be calculated once and reused.] Similarly, each node except the last node, which calculates the highest order component of the final product, also calculates a carry. And the equations for this are also very similar. This can be seen by comparing equations (2), (4), (6), (8), and (10).

FIG. 5 is flow chart showing generalized a node-level process 500, in accord with the large-factor multiplication system 400. In an optional step 502 the necessary factor-components are loaded into the subject node. This is optional because the factor-components may already be present, say, as the result of a prior calculation performed by the subject node. Continuing, if the subject node is not the first node, in a step 504 a carry value is received from the next lower order node. If the subject node is not the last node, in a step 506 a carry value is calculated and in a step 508, this carry value is passed to the next higher order node. In a step 510 the product-component is calculated. In an optional step 512 this product-component is passed out of the subject node. This is optional because the product-component may not be used elsewhere, say, because it is only to be used in a subsequent calculation performed by the subject node.

Turning now to the use of the large-factor multiplication system 400 in a much larger context, for very large-factor multiplication it is likely that several sub-multiplications will be necessary. Then it is important to keep track of the stage and what the various factor-components, and product-components represent relative to the original multiplication. The following formula can be used to determine the partial product positioning and the number of trailing zeros needed:

# of trailing zeros=(stage #)*(# of digits or bits representing each component). (12)

Of course, equation (12) can also be used for the sub-multiplications.

Another of the few requirements for use of the inventive large-factor multiplication system 400 is that the factors are parsed into components having the same number of digits (or bits). When an unequal parsing of the factors is used an incorrect result is likely to be produced. This requirement was met in the example above where the factors ABC and XYZ uniformly use 7-bit components for A, B, C, X, Y, and Z.

Generalizing, the factor ABC can represent e digits where e>0 and e is a natural number, and the factor XYZ can represent f digits where f>0 and f is a natural number. The representations of the components A, B, C, X, Y, and Z can include leading zeroes, flexibly permitting an infinite number of parsings of the factors ABC and XYZ. However, such parsings should still have the number of digits (or bits) used to represent the components A, B, C, X, Y, and Z be equal. For instance, the multiplication of a 12-digit value u₁₂ . . . u₁, where u₁ represents a single digit, with a 5-digit value v₅ . . . v₁, where vⱼ represents a single digit, could include (but is not limited to) the following component representations for ABC and XYZ: A=u₁₂u₁₁u₁₀u₉, B=u₈u₇u₆u₅, C=u₄u₃u₂u₁, X=0000, Y=000v₅, and Z=v₄v₃v₂v₁ or A=000u₁₂u₁₁, B=u₁₀u₉u₈u₇u₆, C=u₅u₄u₃u₂u₁, X=00000, Y=00000, and Z=v₅v₄v₃v₂v₁. Notice that either representation of the components A, B, C, X, Y, and Z results in a parsing in which the number of digits for each component is equal. Again, it is important to note that there are potentially an infinite number of parsings for a particular set of factors and while finding the most appropriate parsing for a given set of factors is not the focus of this discussion, a key aspect of parsing that the components of the factors are represented with the same number of digits (or bits).

It is important to note that the inventive large-factor multiplication system 400 is not restricted to base 10 values and can also be used for binary representations. This leads to another important requirement, one regarding the parsing of factors into components.

Using ABC and XYZ again for the sake of example, if A corresponds to p digits, B corresponds to q digits, and C corresponds to r digits then the factor ABC has p+q+r digits. The second condition is that ABC when parsed into A, B, and C: C represents the r LSd's of factor ABC (still ordered from the LSd of ABC to digit r of ABC), B represents the q digits where the LSd of B is the (r+1)^{th} digit of ABC and the MSd of B is the (r+q)^{th} digit of ABC (still ordered from the (r+1)^{th} digit of ABC to the (r+q)^{th} digit of ABC), and C represents the p digits where the LSd of A is the (r+q+1)^{th} digit of ABC and the MSd of A is the (r+q+p)^{th} digit of ABC (still ordered from the (r+q+1)^{th} digit of ABC to the (r+q+p)^{th} digit of ABC). This keeps the necessary ordering of factor ABC when it is parsed into A, B, and C. Of course, the same applies to factor XYZ and its components X, Y, and Z.

It should also be noted that the inventive large-factor multiplication system 400 is quite flexible. It can be used when the factors ABC and XYZ are represented using the traditional left to right, highest to lowest digit (or bit) ordering. Alternately, it can be used when the factors are represented using the non-traditional right to left, lowest to highest digit (or bit) ordering. The only difference is that the latter case, when viewed in the traditional sense, is now the multiplication of factors CBA and ZYX. The ability to use the large-factor multiplication system 400 for performing multiplication regardless of the orientation of the factors, traditionally or non-traditionally, is an unusual trait. Furthermore, the large-factor multiplication system 400 even has limited utility when one factor is represented in the traditional manner and the other is represented in the non-traditional manner. The results in this situation, however, will only be correct when one or both of the factors is a number palindrome.

While various embodiments have been described above, it should be understood that they have been presented by way of example only, and that the breadth and scope of the invention should not be limited by any of the above described exemplary embodiments, but should instead be defined only in accordance with the following claims and their equivalents.

THIS CORRESPONDENCE CHART IS FOR EASE OF UNDERSTANDING AND INFORMATIONAL PURPOSES ONLY, AND DOES NOT FORM A PART OF THE FORMAL PATENT APPLICATION.
100 traditional method
102-118 stages
150 table
152 final product
200 alternate method
202-210 stages
250 table
252 final product
260-276 rows
280-290 columns
400 large-factor multiplication system 402 array
402 processor array
404-414 nodes
416 (collection) element

What is claimed is:

1. A processor to calculate a product-component having fewer digits than an entire product of a multiplication of a multiplicand and a multiplier, comprising:
a memory to hold at least one multiplicand-component having fewer digits than said multiplicand and to hold at least one multiplier-component having fewer digits than said multiplier; and
a logic to calculate said product-component based on said multiplicand-components and said multiplier-components in said memory.

2. The processor of claim 1, further comprising a port to provide said product-component to a device external to the processor.

3. The processor of claim 1, further comprising:
a port to accept a carry-value from a device external to said processor, wherein said device may be another processor;
and wherein:
said memory is further to hold said carry-value; and
said logic is additionally to calculate said product-component based on said carry-value.

4. The processor of claim 1, further comprising:
a logic to calculate a carry-value based on said multiplicand-components and said multiplier-components in said memory; and
a port to provide said carry-value to a device external to said processor, wherein said device may be another processor.

5. The processor of claim 4, wherein said logic to calculate a carry-value calculates said carry-value before said logic to calculate said product-component calculates said product-component.

6. The processor of claim 1, wherein the processor is one of a plurality of like processors present together in a single module or semiconductor die.

7. A process to calculate a product-component having fewer digits than an entire product of a multiplication of a multiplicand and a multiplier, the method comprising:
providing at least one multiplicand-component having fewer digits than said multiplicand;
providing at least one multiplier-component having fewer digits than said multiplier; and
calculating said product-component based on said multiplicand-components and said multiplier-components.

8. The process of claim 7, further comprising:
accepting a carry-value from a device external to where the process is performed;
and wherein:
said calculating said product-component is further based on said carry-value.

9. The process of claim 7, further comprising:
calculating a carry-value based on said multiplicand-components and said multiplier-components; and
providing said carry-value to a device external to where the process is performed.

10. The process of claim 9, wherein said calculating a carry-value is performed before said calculating said product-component.

11. A system to multiply a multiplicand and a multiplier to calculate a product, wherein said multiplicand is represented by multiple multiplicand-components each having fewer digits than said multiplicand, said multiplier is represented by multiple multiplier-components each having fewer digits than said multiplier, and said product is represented by multiple product-components each having fewer digits than said product, the system comprising:
a plurality of processors ordered lowest, middle, and highest based on an ordering of said product-components in said product, said plurality of processors including:
a said lowest said processor having:
a carry-value logic to calculate and provide a carry-value to another said processor; and
a product-component logic to calculate a product-component;
one or more said middle said processors each having a said carry-value logic and a product-component logic; and
a said highest said processor having a said product-component logic;
wherein:
in said carry-value logic in said lowest said processor, said carry-value is calculated based on a said multiplicand-component and a said multiplier-component;
in said carry-value logic in said middle said processors, said carry-value is calculated based on at least one said multiplicand-component, at least one said multiplier-component, and a said carry-value that was calculated by another said processor;
in said product-component logic in said lowest said processor, said product-component is calculated based on a said multiplicand-component and a said multiplier-component;
in said product-component logic in said middle said processors, said product-component is calculated based on at least one said multiplicand-component, at least one said multiplier-component, and a said carry-value that was calculated by another said processor; and
in said product-component logic in said highest said processor, said product-component is calculated based on a said carry-value that was calculated by another said processor.

12. The system of claim 11, wherein each said processor includes a port to provide its respective said product-component to a device external to said processor.

13. The system of claim 11, wherein, in said lowest said processor and said middle said processors, said carry-value logic calculates said carry-value before said product-component logic calculates said product-component.

14. The system of claim 11, wherein said respective product-component logics calculate their respective product-components substantially contemporaneously.

15. The system of claim 11, wherein plurality of processors are present together in a single module or semiconductor die.

16. A method to multiply a multiplicand and a multiplier with a plurality of processors to obtain a product, the method comprising:
(a) representing said multiplicand as multiple multiplicand-components each having fewer digits than said multiplicand;
(b) representing said multiplier as multiple multiplier-components each having fewer digits than said multiplier;
(c) representing said product as multiple product-components in an order, each having fewer digits than said product;
(d) ordering said plurality of processors lowest, middle, or highest based on said order;
(e) providing at least one said multiplicand-component and at least one said multiplier-component in said lowest said processor and in each said middle said processor;
(f) calculating a respective carry-value in each of said lowest said processor and said middle said processors;
(g) providing each said respective carry-value to a said processor higher in said ordering; and
(h) calculating a respective product-component in each of said plurality of processors.

17. The process of claim 16, wherein said calculating of said respective product-components is performed substantially contemporaneously.

18. The process of claim 16, wherein:
said multiplicand is a first sub-factor and said multiplier is a second sub-factor in a greater multiplication wherein said product is itself a said multiplicand or a said multiplier, thereby permitting use of the process in a recursive manner to multiply large values.
